(19) United States
(12) Patent Application Publication
(10) Pub. No.: US 2012/0067997 A1
(43) Pub. Date: Mar. 22, 2012

(54) Optical Fiber Spool Inspection System

(75) Inventor: Andrew L. Ingles, Alpharetta, GA (US)

(73) Assignee: OFS FITEL, LLC, Norcross, GA (US)

(21) Appl. No.: 12/886,662

(22) Filed: Sep. 21, 2010

(51) Int. Cl. B65H 54/00; G06K 9/00

(52) U.S. Cl. 242/470; 382/141

(57) ABSTRACT

Methods and systems for inspecting a bare optical fiber spool are disclosed. The system inspects the bare optical fiber spool prior to optical fiber winding and determines whether the bare optical fiber spool is acceptable for the winding.

### TECHNICAL FIELD

The invention relates to optical fiber spools. More particularly, the present invention relates to methods and apparatus for inspecting the optical fiber spools.

### BACKGROUND OF THE INVENTION

Optical fiber has become a widely accepted form of transmission media. In the current manufacturing process for optical fiber, a continuous length of optical fiber is drawn from an optical preform, which may be made by any one of several known processes; then the drawn fiber is coated with one or more coatings and subsequently cured. The coated optical fiber is typically wound onto a spool for measurement, testing, storing and/or shipping. The spooled optical fiber can be used for paying out the fiber for other operations such as ribboning, cabling and rewinding. Also, it can be shipped to other companies for further processing the optical fiber.

When the spooled optical fiber is unwound for further processing, a fiber spooling machine is used to unwind the optical fiber from a payout spool. When the optical fiber is unwound, a device that tracks the position of the fiber as it comes off the payout spool is often required. This device is referred to as a follower and ensures that the path of the fiber coming off the spool is perpendicular with respect to the spool's axis of rotation.

If the fiber spooling machine only unwinds a spool with a known and consistent fiber winding pitch and known and consistent spool dimensions, there is no problem in unwinding the optical fiber. However, spooled optical fiber with known and consistent fiber winding pitch and spool dimensions are rarely the case. Many variables can complicate the required operation of the follower. For example, spool flange dimensions may vary due to wear or manufacturing tolerances, the fiber may not be wound evenly, and the follower linear axis may set up incorrectly with respect to the position of the spools.

A poorly wound payout spool with abnormally large material pitch variations may prevent rapid unwinding and create a risk for damaging or cutting the optical fiber during the payout for further processing or rewinding. The poorly wound spool reduces manufacturing efficiency and increases the risk of producing scraps.

U.S. Pat. No. 5,590,846 discloses a system for monitoring and correcting the winding of an optical fiber on a bobbin, and a method for such winding. The system comprises a conventional winding device combined with an indirect illumination of the fiber for projecting an enlarged silhouette of the uppermost layer of such filament on a screen as it is wound under controlled tension onto the bobbin, and a mechanism for interrupting such winding and effecting corrections whenever required.

However, poorly wound spools still exist and a need remains for improved spool winding for rapid unwinding.

### BRIEF SUMMARY OF THE INVENTION

Some or all of the above needs may be addressed by certain embodiments of the invention. Certain embodiments of the invention include systems and methods for inspecting an optical fiber spool.

According to an example embodiment of the invention, a method for inspecting an optical fiber spool is provided. The method includes inspecting a bare optical fiber spool with a visual inspection system, which stores ideal shape information and associated tolerance limits; comparing the inspection data with the stored shape information; determining if the bare optical fiber spool is within the stored tolerance limits; and indicating pass or fail of the bare optical fiber spool based on the determination.

According to another example embodiment, an optical fiber spool inspection system is provided. The optical fiber spool inspection system includes a spool mounting unit configured to mount a bare optical fiber spool, a visual inspection unit facing the bare optical fiber spool, and a computer connected to the visual inspection unit for obtaining inspection data. The computer compares the inspection data with stored data for an ideal shape of the bare optical fiber spool and determines if the bare optical fiber spool is within tolerance limits.

According to yet another example embodiment, a method for fabricating an optical fiber spool is provided. The method includes measuring a spool surface of a bare optical fiber spool on which an optical fiber is to be wound to obtain, shape data, comparing the measured shape data against predetermined shape data to determine whether the surface is acceptable for winding the optical fiber thereon, and winding the optical fiber onto the bare optical fiber spool after the spool surface has been determined to be acceptable.

Other embodiments and aspects of the invention are described in detail herein and are considered a part of the claimed invention. Other embodiments and aspects can be understood with reference to the following detailed description, accompanying drawings, and claims.

### BRIEF DESCRIPTION OF THE DRAWINGS

Reference will now be made to the accompanying figures and flow diagrams, which are not necessarily drawn to scale, and wherein:

FIG. 1 is a schematic view of a bare optical fiber spool inspection system, according to an example embodiment of the invention.

FIG. 2 is a schematic view of a bare optical fiber spool attached to a spool mounting unit.

FIG. 3 is a schematic view of the bare optical fiber spool attached to the spool mounting unit in another way.

FIG. 4 is a schematic view of the bare optical fiber spool attached to the spool mounting unit in yet another way.

FIG. 5 is a flow diagram of an example method, according to an example embodiment of the invention.

FIG. 6A is a schematic view of a bare optical fiber spool with defects.

FIG. 6B is a schematic view of the bare optical fiber spool with defects in another view.

FIG. 7 is a flow diagram of another example method, according to an example embodiment of the invention.

FIG. 8 is a schematic view of the bare optical fiber spool with a pad.

FIG. 9 is a flow diagram of yet another example method, according to an example embodiment of the invention.

FIG. 10 is a schematic view of another bare optical fiber spool inspection system, according to an example embodiment of the invention.

### DETAILED DESCRIPTION

In the following description, similar components are referred to by the same reference numeral to enhance the understanding of the invention through the description of the drawings. Also, unless otherwise explicitly specified herein, the drawings are not drawn to scale.

Although specific features, configurations and arrangements are discussed herein below, it should be understood that such is done for illustrative purposes only. A person skilled in the relevant art will recognize that other steps, configurations and arrangements are useful without departing from the spirit and scope of the invention.

One of the reasons for poorly wound optical fiber spools is the spool. Dimensions of the spool may vary due to wear or manufacturing tolerances. Example causes of the wear are including but not limited to temperature cycle, mechanical stress, transportation, drop and dent. If the dimensions of a spool are vary from ideal dimensions, a winding machine cannot wind the optical fiber evenly and consistently onto the spool, which results in a poorly wound spool.

The inventor of the present invention realized that an inspection of a bare optical fiber spool before winding any optical fiber onto the spool, is one way to avoid, such poorly wound spools. By inspecting the spool before winding, an operator can remove highly deviated spools, and the inspection data can be used by a fiber spooling machine for optimized winding. Embodiments and aspects of the invention are described in detail hereafter and can be understood with reference to accompanying drawings.

In this specification, the term “bare optical fiber spool” as used herein refers to an empty optical fiber spool without any optical fiber is wound onto the spool. The bare optical fiber spool may have wound optical fibers before; however, the bare optical fiber spool does not have any optical fibers when the spool is inspected.

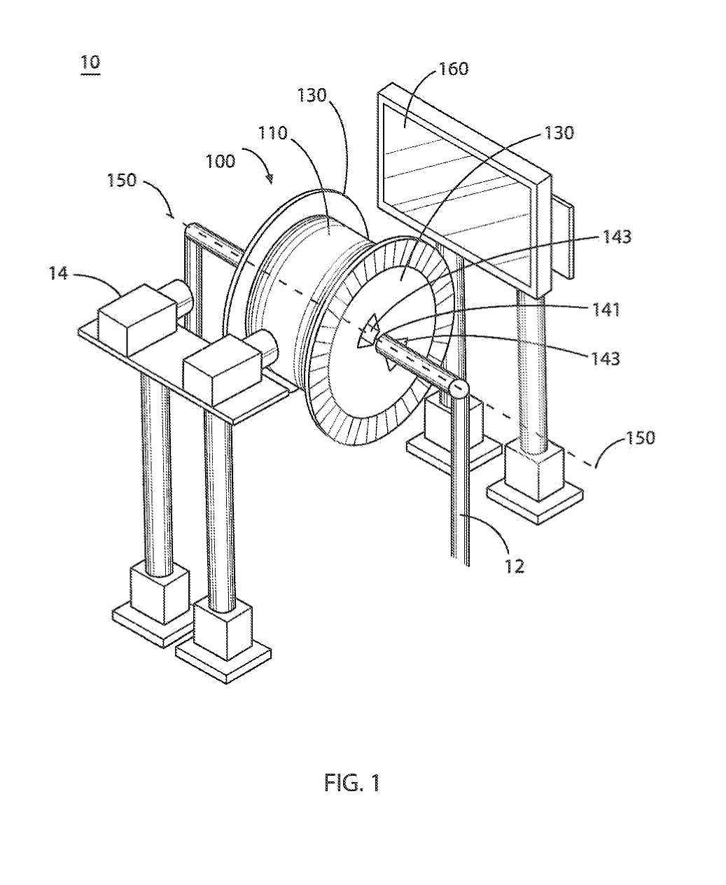

Referring to FIG. 1, an overview of an exemplary embodiment bare optical fiber spool inspection system 10 according to the present invention will be described. The inspection system 10 comprises a spool mounting unit 12 configured to mount a bare optical fiber spool 100, a visual inspection unit 14 facing the bare optical fiber spool 100 and a computer (not shown) connected to the visual inspection unit 14 for obtaining inspection data. The computer compares the inspection data with stored data for an ideal shape of the bare optical fiber spool and determines if the bare optical fiber spool is within stored tolerance limits. Based on the determination, the bare optical fiber spool system 10 indicates pass or fail result of the bare optical fiber spool 100.

The bare optical fiber spool 100 has a cylindrical barrel 110 and two flanges 130 facing each other with the cylindrical barrel 110 in between. The cylindrical barrel 110 is configured to wind an optical fiber around. The bare optical fiber spool 100 may be made of a polyethylene, ABS material or a cellular styrene material.

Typically, the bare optical fiber spool 100 has a central opening 141 and a plurality of arcuately shaped openings (in FIG. 1, two arcuately shaped openings 143 are shown) on each of the flanges 130. Sometimes, the bare optical fiber spool 100 also has a plurality of other openings (not shown) on each of the flanges 130 as well. The central opening 141 is adapted to receive an arbor of a winding or payout apparatus (not shown) whereas the openings 143 and other openings (not shown) are adapted to receive driving rods of take-up or payout apparatus or fingers of operators wishing to reposition or transport the spools. After an optical fiber is wound, an optical fiber spool can be used to store and/or transport the wound optical fiber.

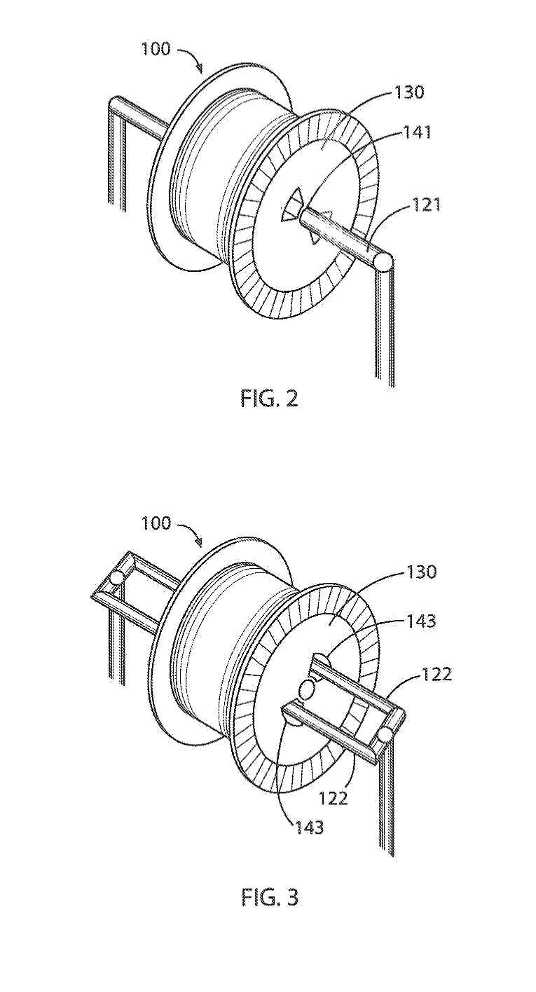

FIG. 2 shows one method to mount the bare optical fiber spool 100 onto the spool mounting unit 12 of the bare optical fiber spool inspection system 10. An arbor 121 of the spool mounting unit 12 is inserted to the central opening 141 of the bare optical fiber spool 100. This mounting can be done manually by an operator or automated.

FIG. 3 shows another method to mount the bare optical fiber spool 100 onto the spool mounting unit 12. Two arbors 122 of the spool mounting unit 12 are inserted to the two arcuately shaped openings 143 of the bare optical fiber spool 100. This mounting can be done manually by an operator or automated. In FIG. 3, two arcuately shaped openings 143 are used; however, any plurality of openings (not shown) on each of the flanges 130 can be used to mount the bare optical fiber spool 100. Any number of openings and any combination of openings can be used to mount the bare optical fiber spool 100 onto the spool mounting unit 12.

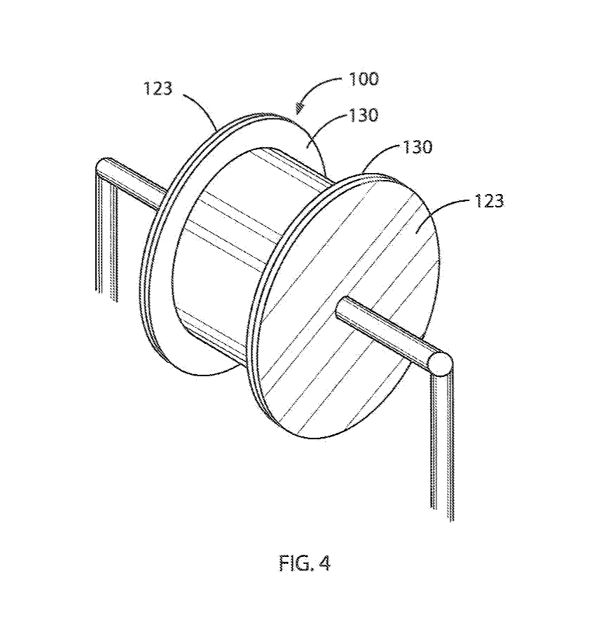

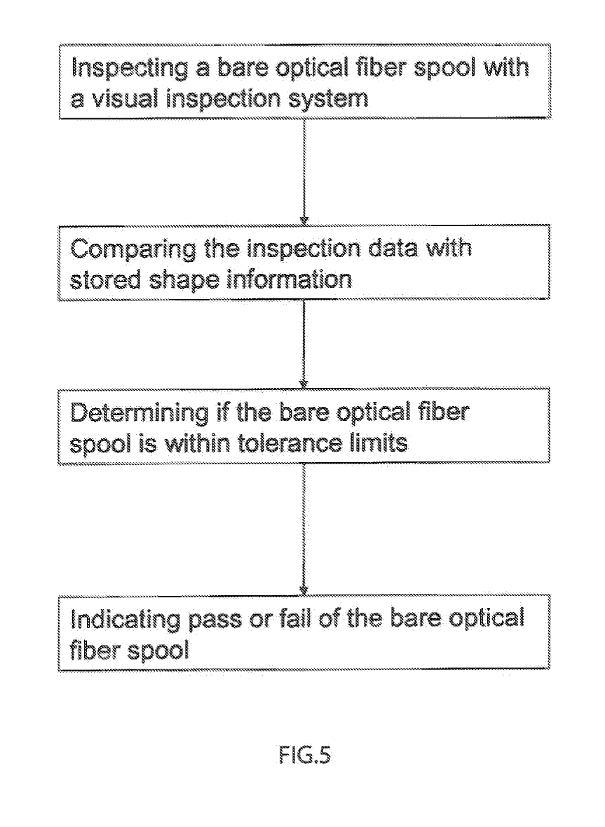

FIG. 4 shows yet another method to mount the bare optical fiber spool 100 onto the spool mounting unit 12. The spool mounting unit 12 has two pads 123. The two pads 123 hold the bare optical fiber spool 100 from both sides of the spool 100. A predetermined pressure is applied from the pads 123 to the flanges 130 to hold the bare optical fiber spool 100. Preferably, the contacting surface of the pads 123 is made by a rubber material for better grip and dissipating excess pressure. This mounting can be done manually by an operator or automated.

Three exemplary methods to mount the bare optical fiber spool 100 onto the spool mounting unit 12 are shown above. However, the scope of the present invention does not limits to such exemplary methods; and the scope of the present invention includes any other mounting methods, which a person skilled in the relevant art will recognize as useful without departing from the spirit and scope of the invention.

Referring back to FIG. 1, the visual inspection unit 14 can sense the presence and/or position of the bare optical fiber spool 100 and obtain visual image(s) of the bare optical fiber spool 100. More specifically, the visual inspection unit 14 senses the presence and/or position of a spooling area of the bare optical fiber spool 100 and obtain the visual image(s) thereof. The spooling area comprises a field of detection between the bare optical fiber spool 100 and the visual inspection unit 14 including at least part of the area between and adjacent to the flanges 130 of the bare optical fiber spool 100. For example, the visual inspection unit 14 senses the outer surface of the cylindrical barrel 110 and the inner surfaces of the two flanges 130, which are facing each other as a spooling area.

The bare optical fiber inspection system 10 may have light source 160 for illumination purpose. The light source 160 can be used to silhouette the bare optical fiber spool 100 for better inspection by the visual inspection unit 14. For example, high intensity LED lights can be used as the light source.

A bare optical fiber spool may have only one flange, or a bare optical fiber spool may be flangeless. The bare optical fiber spool 100 is an exemplary device, as the present invention may be practiced on other elongated winding devices such as a drum, a cylinder, or a coiling device. If the spool is flangeless, a spooling surface is the surface of a core of any suitable elongated winding device that longitudinally extends along the axis of rotation. As one skilled in the art will realize, the core may be a solid cylinder or merely longitudinal spokes or a solid spindle; and the axis of rotation can be horizontal, vertical, or at any suitable angle.

Typically, the visual inspection unit 14 can be programmed to monitor the spooling area (or the spooling surface), generate a position signal indicating presence and/or position of the spool area and obtain visual image(s) of the spooling area. The visual inspection of the spooling area may be performed continuously at given time intervals, or may be limited by the ability of the visual inspection unit 14 or the processing rate of the computer, which is connected to the visual inspection unit 14. The information contained in the position signal can be utilized by a control unit such as a computer connected to the visual inspection unit 14 to monitor the spooling area and/or control the bare optical fiber spool inspection system 10.

The visual inspection unit 14 may be any suitable system that is able to sense the presence and position of the bare optical fiber spool 100. For example, the visual inspection unit 14 can be a camera for obtaining one or more images of at least a portion of the bare optical fiber spool 100 with corresponding positional signal. The position of the visual inspection unit 14 is not limited to what is shown in FIG. 1. The visual inspection unit 14 can be placed at any suitable location as long as the visual inspection unit 14 can sense the presence and/or position of the spooling area of the bare optical fiber spool 100 and obtain the visual image(s) thereof. Also, the visual inspection unit 14 can be fixed or movable with respect to the bare optical fiber spool 100 and/or the optical fiber spool inspection system 10. Further more, numerous mechanical and/or electromechanical detectors such as proximity sensors may be utilized.

The visual image(s) from the visual inspection unit 14 is sent to a computer connected to the visual inspection unit 14 for further analysis. The computer compares the visual image(s) of the bare optical fiber spool 100 with an ideal shape of the bare optical fiber spool 100. More specifically, the spool area of the bare optical fiber spool 100 is compared with the ideal spool area of the bare optical fiber spool 100. The information about the ideal shape of a corresponding bare optical fiber spool is stored in the computer in advance, and the computer can store information about plurality of bare optical fiber spools in different configurations and/or sizes. Optionally, such information can be stored in a server, which the computer accesses the information through a computer network. An operator can select information about the specific bare optical fiber spool to be tested manually or the computer can be preconfigured to select such information automatically.

When the computer compares the visual image(s) of the bare optical fiber spool 100 to an ideal shape of the bare optical fiber spool 100, the computer determines if the bare optical fiber spool 100 is within tolerance limits. In the present exemplary embodiment of the present invention, a grid is used to compare the bare optical fiber spool 100 to the ideal shape thereof, and the difference in the shapes between the bare optical fiber 100 and the ideal shape thereof is measured. This comparison process is an automatic process, and in preferred embodiments, an operator can see the process through e.g. a computer screen and the comparison data can be stored for later use and/or analysis. Then, the difference in shapes is compared with the tolerance limits. The tolerance limits can be any predetermined value and can be different for different portions of interest (e.g. the tolerance limits for the outer surface of the cylindrical barrel 110 may be different from that of the inner surface of the two flanges 130). The tolerance limits may be different for different type/size of spools. For example, in one of the preferred embodiments, a tolerance limits are approximately ±0.1 mm from the ideal shape of a bare optical fiber spool. The tolerance limits can be stored in the computer in advance or can be entered manually by an operator before the inspection. If the tolerance limits is stored in a computer, then the computer can store tolerance limits of plurality of bare optical fiber spools in different configurations and/or sizes. The computer also can store different predetermined tolerances limits for different portions of interest within a specific bare optical fiber spool to be inspected.

After the computer determines if the bare optical fiber spool 100 is within the tolerance limits, the bare optical fiber inspection system 10 indicates pass or fail result. If the bare optical fiber spool 100 is within the corresponding tolerance limits, then the bare optical fiber inspection system 10 will indicate pass result. If the bare optical fiber spool 100 exceeds the corresponding tolerance limits, then the bare optical fiber inspection system 10 will indicate fail result.

The computer may be a separate component of the bare optical fiber spool inspection system 10, or it may be integrated into one or more system components, such as the visual inspection unit 14. Suitable examples of the computer include personal computers, processors, microprocessors, hard-wired processors or controllers such as a programmable logic unit, servers, mainframe computers, and computer workstations.

The inspection system 10 may optionally include a display (not shown) or a monitor (not shown) for displaying data and/or signals from the visual inspection unit 14, the computer, the spool mounting unit 12 and/or other parts of the inspection system 10. For example, information such as inspection data/image(s) of the spool, data/image(s) of the ideal shape of the spool, difference in the shapes between the bare optical fiber and the ideal shape thereof, tolerance limits, and pass/fail result of an inspection can be displayed. The display (or the monitor) can show such information for a single inspection or plurality of inspections at once.

The bare optical fiber spool inspection system 10 may be associated with a winding apparatus, which winds an optical fiber onto the bare optical fiber spool 100 after the inspection. Or the bare optical fiber spool inspection system 10 can be used as a stand alone apparatus.

In one embodiment, referring to FIG. 5, a method according to the present invention for inspecting a bare optical fiber spool 100 includes inspecting the bare optical fiber spool 100 with a visual inspection system 10 (block 501). The bare optical fiber spool visual inspection system 10 stored ideal shape information and associated tolerance limits. Then, the visual inspection system 10 compares the inspection data with the stored shape information inspecting the bare optical fiber spool with a visual inspection system (block 502). The bare optical fiber spool visual inspection system 10 also determines if the bare optical fiber spool 100 is within the tolerance limits (block 503). Then, the bare optical fiber spool visual inspection system 10 indicates pass or fail of the bare optical fiber spool 100 based on the determination (block 504). This is one method to inspect a bare optical fiber by the present invention, and a person skilled in the relevant art will realize other similar methods as useful without departing from the spirit and scope of the invention.

Referring back to FIG. 1, the spool mounting unit 12 can be configured to rotate the bare optical fiber spool 100 about its central axis 150 relative to the bare optical fiber spool visual inspection system 10 during the inspection, and the visual inspection unit 14 can be configured to collect data at a plurality of predetermined rotational angles.

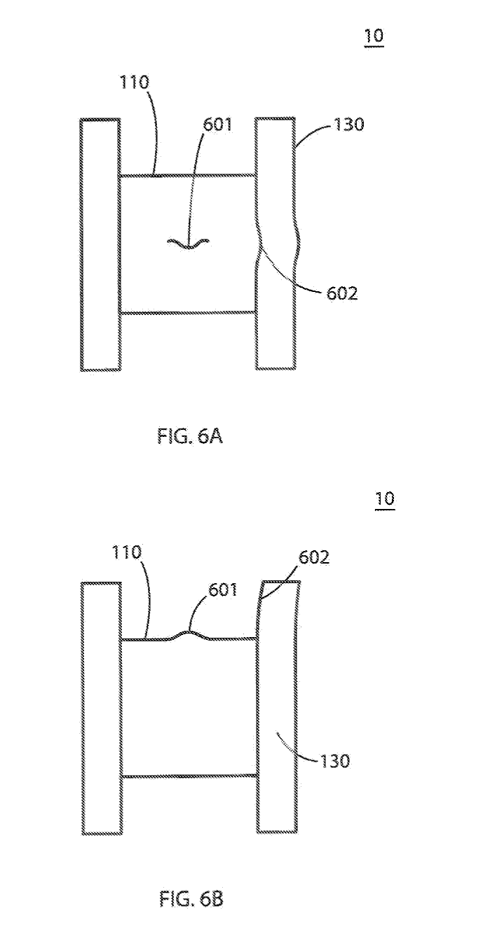

By rotating the bare optical fiber spool 100 relative to the bare optical fiber spool visual inspection system 10, more accurate inspection data about the bare optical fiber spool 100 can be obtained. For example, referring to FIG. 6A, a defect 601 on the outer surface of the cylindrical barrel 110 and another defect 602 on the inner surface of the flange 130 facing at the front of the visual inspection unit 14 are difficult to detect. Also, if such defects are behind the bare optical fiber spool 100, then the visual inspection unit 14 cannot detect such defects. However, referring to FIG. 6B, by rotating the defective portion(s) to preferred detective areas such as the top or the bottom portion of the bare optical fiber spool 100 from the viewpoint of the visual inspection unit 14, such defects 601 and 602 can be easily and more accurately detected by the visual inspection unit 14.

Referring back to FIG. 1, the computer connected to the visual inspection unit 14 can have, for example, a memory and/or a processor for respectively storing and executing operations. For example, the computer can cooperate with the spool mounting unit 12 and/or the visual inspection unit 14 to monitor and analyze the presence and/or position of any defects on the bare optical fiber spool 100 while the bare optical fiber spool 100 is rotating. The computer may or may not be connected to the spool mounting unit 12. If the computer is not connected to the spool mounting unit 12, spool rotation settings can be stored in the computer in advance or can be entered manually by an operator before the inspection. The spool rotation settings include but not limited to rotational velocity (or speed), duration of the rotation and the direction of the rotation. The computer may send signal for controlling the spool mounting unit 12 and/or the visual inspection unit 14 by, for example, controlling the spool rotational speed and/or controlling the torque applied to the bare optical fiber spool 100.

The visual inspection unit 14 can be programmed to inspect the spooling area, generate positional signal(s) indicating the presence and/or position of the spool surface corresponding to a detection time while taking visual images of the bare optical fiber spool 100. The inspection of the spooling area may be performed continuously at given time intervals, or may be limited by the sampling rate of the visual inspection unit 14 or the processing rate of the computer. The information contained in the positional signal can be utilized by the computer to inspect the spooling area and control the spool mounting unit 12.

The computer can be programmed to, for example, optimize spool inspection setting such as the predetermined rotational angle. To optimize the spool inspection setting, the computer may control the spool mounting unit 12, for example, by varying the rotational speed and/or torque of the spool mounting unit 12; and/or the computer may control the visual inspection unit 14, for example, by varying the sampling rate, position and/or optical settings. When the rotational speed and/or the torque of the spool mounting unit 12 changes, the bare optical fiber spool 100 can be subjected to continuous increase or decrease of the rotational speed and/or the torque applied or can be subjected to discontinuous increase or decrease of the rotational speed and/or the torque applied (e.g. the spool is rotated by some angle, then the spool stopped for inspection). In some embodiments of the present invention, the predetermined rotational angles are approximately 5, 10, 15 or 20 degrees. In such embodiments, the visual inspection unit 14 takes visual image(s) of the bare optical fiber spool 100 facing toward the visual inspection unit 14 at a plurality of predetermined rotational angles. The spool can still be rotated or can be stopped when the image is taken at the plurality of predetermined rotational angles.

The spool mounting unit 12 may have a motor (not shown) operatively associated with the bare optical fiber spool 100 for rotating the bare optical fiber spool 100 at controllable speed and torque. The spool mounting unit 12 may further include a controllable brake (not shown) for impeding or stopping the rotation of the bare optical fiber spool 100.

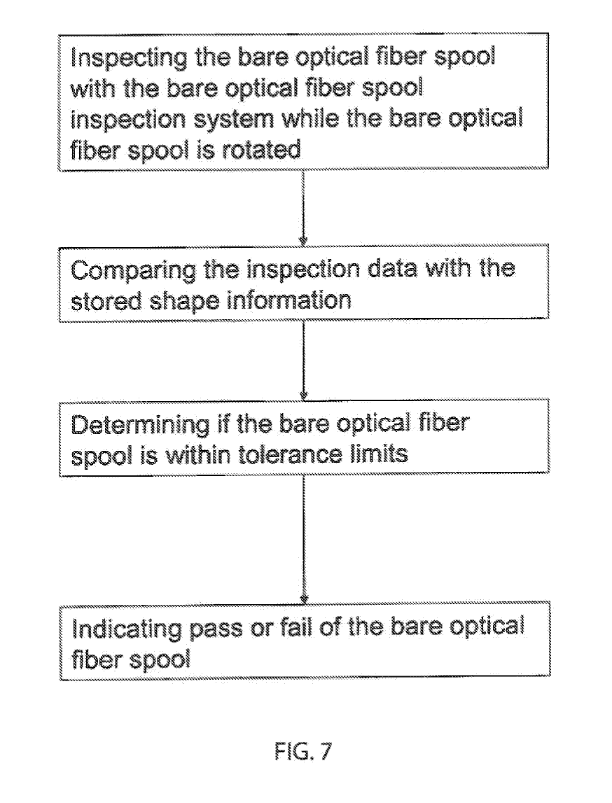

In one embodiment, referring to FIG. 7, a method according to the present invention for inspecting a bare optical fiber spool 100 includes inspecting the bare optical fiber spool 100 with the bare optical fiber spool inspection system 10 while the bare optical fiber spool 100 is rotated about its central axis 150 relative to the bare optical fiber spool inspection system 10, and the inspection data is collected at a plurality of predetermined rotational angles (block 701). Ideal shape information and associated tolerance limits are stored in the bare optical fiber spool inspection system 10 in advance. The bare optical fiber spool inspection system 10 compares the inspection data with the stored shape information (block 702). The bare optical fiber spool inspection system 10 also determines if the bare optical fiber spool 100 is within tolerance limits (block 703). Then, the bare optical fiber spool inspection system 10 indicates pass or fail of the bare optical fiber spool 100 based on the determination (block 704). This is one method to inspect a bare optical fiber by the present invention, and a person skilled in the relevant art will realize other similar methods as useful without departing from the spirit and scope of the invention.

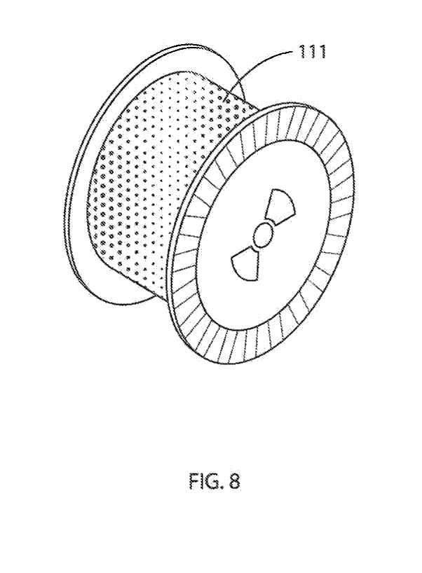

In one embodiment, referring to FIG. 8, the bare optical fiber spool 100 includes a sponge pad 111 for covering the outer surface of the cylindrical barrel 110. The pad 111 serves as a shock-absorbing agent to relieve impacts for the optical fiber to be wound. In a preferred embodiment, the pad 111 may be made of a polyurethane or polyethylene material and has a thickness of approximately 0.48 cm.

Because wear and tear, uneven thickness and uneven edges of the pad 111, too wide pad 111 (i.e. the width of the pad 111 is longer than the width of the cylindrical barrel 110), and/or too narrow pad 111 (i.e. the width of the pad 111 is shorter than the width of the cylindrical barrel 110) may cause problem in winding an optical fiber, inspection of the bare optical fiber spool 100 with the sponge pad 111 is also important for rapid unwinding.

The visual inspection system 10 can be used to inspect the bare optical fiber spool 100 with the sponge pad 111. The inspection is similar to the inspection of the bare optical fiber spool 100 without the pad 111. However, when comparing the inspection data with the stored shape information and when determining if the bare optical fiber spool is within tolerance limits, the ideal shape information and the associated tolerance limits stored in the visual inspection system 10 incorporates ideal shape information regarding the pad 111. The ideal shape information regarding the pad 111 also includes associated tolerance limits regarding the pad 111. Also, the bare optical fiber spool 100 with the pad 111 can be rotated in the same manner as it was for the bare optical fiber spool 100 without the pad 111 during a inspection.

Furthermore, after the bare optical fiber spool 100 (with or without the pad 111) is inspected, an optical fiber is wound onto the bare optical fiber spool 100. More particularly, after the spooling surface has been determined to be acceptable, the optical fiber is wound onto the bare optical fiber spool 100 for fabrication.

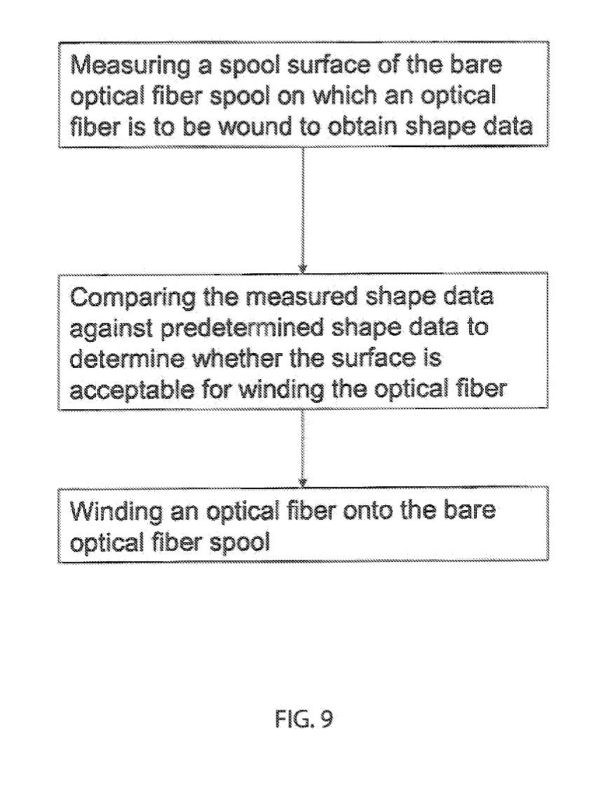

In one embodiment, referring to FIG. 9, a method according to the present invention for fabricating an optical fiber spool 100 includes measuring a spool surface of the bare optical fiber spool 100 on which an optical fiber is to be wound to obtain shape data (block 901). The measured shape data is compared against predetermined shape data to determine whether the surface is acceptable for winding the optical fiber (block 902). After the spooling surface has been determined to be acceptable, the optical fiber is wound onto the bare optical fiber spool 100 (block 903).

The shape data can be obtained from any mean. Preferably, the shape data is obtained using the visual inspection unit described above. However, mechanical inspection unit such as a projection disclosed hereafter is also a mean to obtain such shape data from the bare optical fiber spool 100.

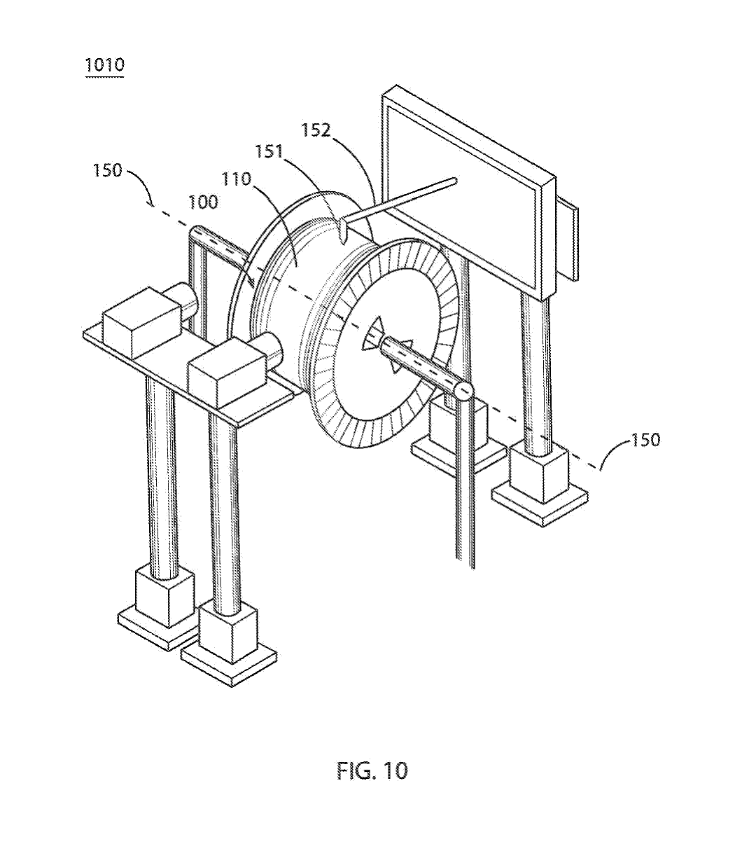

Referring to FIG. 10, the optical fiber inspection system 1010 includes a projection 152 with a sensing member 151 that projects generally towards spooling area. The sensing member 151 can preferably contact the surface of the cylindrical barrel 110. The sensing member 151 can be biased in contact with the surface of the cylindrical barrel 110, such as by gravitational force and/or a spring biasing device, for example, to substantially reduce or prevent jumping and bouncing of the sensing member 151 against the surface of the cylindrical barrel 110. The sensing member 151 can cover a substantial portion of the axial and/or radial length of the surface of the cylindrical barrel 110, and preferably is able to detect the surface and/or defects on the surface along multiple points of the axial length of the spooling area to obtain the shape data, then such shape data is sent to the computer for further process. The bare optical fiber spool 100 can be rotated about its central axis 150 relative to the projection 152 in the same manner as it was for the bare optical fiber spool 100 with visual inspection described above, or the projection 152 can be rotated relative to the bare optical fiber 100 to inspect the spooling surface. The sensing member 151 may comprise projection assemblies and components, for example, a sheet-like material, and/or arm-like members. Suitable materials for the sensing member 151 include metals, plastics, composites, and other durable, semi-rigid or flexible materials having relatively smooth finishes that will not harm an operator or the bare optical fiber spool 100. The projection 152 (or other means to obtain the shape data) can be used as a single measurement device to obtain the shape data of the bare optical fiber spool 100 or can be used in combination of other means such as the visual inspection unit 14.

The optical fiber spool inspection systems 10 and 1010 disclosed in the present invention can be designed to flexibly adjust to various spool sizes. Also, the concept of the present invention can be applied to other systems such as cable reel inspection system without departing from the spirit and scope of the invention.

It will be apparent to those skilled in the art that many changes and substitutions can be made to the embodiments of the optical fiber cables herein described without departing from the spirit and scope of the invention as defined by the appended claims and their full scope of equivalents.

What is claimed is:

1. A method for inspecting a bare optical fiber spool comprising the steps of:
inspecting the bare optical fiber spool with a visual inspection system, which has ideal shape information and associated tolerance limits stored therein, to obtain inspection data;
comparing the inspection data with the ideal shape information;
determining if the bare optical fiber spool is within the stored tolerance limits; and
indicating pass or fail of the bare optical fiber spool based on the determination step.

2. The method of claim 1, wherein the stored tolerance limits are approximately ±0.1 mm from the ideal shape of the bare optical fiber spool.

3. The method of claim 1, wherein the bare optical fiber spool is rotated about its central axis relative to the visual inspection system during the inspection step, and the inspection data is collected at a plurality of predetermined rotational angles.

4. The method of claim 3, wherein the rotational angles are separated by approximately 5, 10, 15 or 20 degrees.

5. The method of claim 1, wherein the bare optical fiber spool passes the inspection if the bare optical fiber spool is within the stored tolerance limits.

6. The method of claim 1, wherein the bare optical fiber spool fails the inspection if the bare optical fiber spool exceeds the stored tolerance limits.

7. The method of claim 1, wherein the inspection data is collected from one or more cameras.

8. The method of claim 1, wherein the bare optical fiber spool includes a pad around the outer surface of a cylindrical barrel, and the ideal shape information and the associated tolerance limits stored in the visual inspection system incorporate ideal shape information regarding the pad.

9. An optical fiber spool inspection system comprising:
a spool mounting unit configured to mount a bare optical fiber spool;
a visual inspection unit facing the bare optical fiber spool; and
a computer connected to the visual inspection unit for obtaining inspection data wherein the computer compares the inspection data with stored data for an ideal shape of the bare optical fiber spool and determines if the bare optical fiber spool is within stored tolerance limits.

10. The optical fiber spool inspection system of claim 9, wherein the spool mounting unit is configured to mount the bare optical fiber spool with a pad around the center surface of the bare optical fiber spool, and the computer compares the inspection data with the stored data for the ideal shape of the bare optical fiber spool; wherein the stored data for the ideal shape of the bare optical fiber spool includes data for the ideal shape of the pad.

11. The optical fiber spool inspection system of claim 10, wherein the spool mounting unit is configured to rotate the bare optical fiber spool with the pad about its central axis relative to the visual inspection system, and inspection data is collected at a plurality of predetermined rotational angles.

12. The optical fiber spool inspection system of claim 9, wherein the spool mounting unit is configured to rotate the bare optical fiber spool about its central axis relative to the visual inspection system, and inspection data is collected at a plurality of predetermined rotational angles.

13. The optical fiber spool inspection system of claim 12, wherein the predetermined rotational angles are separated by approximately 5, 10, 15 or 20 degrees.

14. The optical fiber spool inspection system of claim 9, wherein the spool mounting unit has two pads, which are configured to rotate the bare optical fiber spool by holding the bare optical fiber spool from both sides of the spool.

15. The optical fiber spool inspection system of claim 9, wherein the spool mounting unit has a rod, which is configured to rotate the bare optical fiber spool by inserting the rod at the center of the bare optical fiber spool.

16. The optical fiber spool inspection system of claim 9, wherein the spool mounting unit has two or more rods, which are configured to rotate the bare optical fiber spool by inserting the two or more rods around the center of the bare optical fiber spool.

17. The optical fiber spool inspection system of claim 9, wherein the stored tolerance limits are ±0.1 mm from the ideal shape of the bare optical fiber spool.

18. The optical fiber spool inspection system of claim 9, wherein the visual inspection unit is a camera.

19. A method for fabricating an optical fiber spool comprising the steps of:
measuring a spool surface of a bare optical fiber spool on which an optical fiber is to be wound to obtain shape data;
comparing the measured shape data against stored shape data to determine whether the surface is acceptable for winding the optical fiber thereon; and
winding the optical fiber onto the bare optical fiber spool after the spool surface has been determined to be acceptable.

20. The method of claim 19, wherein the measured shape data is obtained using a visual inspection unit.
